(19) United States
(12) Patent Application Publication
(10) Pub. No.: US 2023/0379047 A1
(43) Pub. Date: Nov. 23, 2023

(54) ENABLING LOW-POWER COMMUNICATION BETWEEN A UE AND A NON-TERRESTRIAL NETWORK

(71) Applicant: T-Mobile USA, Inc., Bellevue, WA (US)

(72) Inventor: Shahzad Bashir, Snoqualmie, WA (US)

(21) Appl. No.: 17/751,312

(22) Filed: May 23, 2022

(51) Int. Cl. H04B 7/185; H04B 17/318; H04W 76/10

(52) U.S. Cl. CPC H04B 7/18517; H04B 17/318; H04W 76/10

(57) ABSTRACT

The disclosed system causes a UE to determine a signal strength associated with a communication provided to the UE by a base station. Based on the signal strength, the system causes the UE to determine whether to establish a connection with the base station. Upon determining to not establish the connection with the base station, the system sends a request to the UE to connect to a repeater that includes a first radio and a second radio. The system establishes a communication channel between the repeater and the UE, wherein the communication channel enables the low-power communication of information. The system communicates the information between the first radio and the second radio, encodes the information into a high-power communication, and sends the high-power communication to a non-terrestrial network.

### BACKGROUND

Modern cellular wireless voice, video, and data communication is bidirectional, requiring two-way communication between a base station and a mobile phone. Mobile phones are restricted from transmitting above a certain power to limit radio frequency exposure to the human body when a person is in close proximity, such as when the person is talking into the mobile phone while holding it close to the ear. Consequently, the range of the signal emitted by the mobile phone is limited due to the power constraints.

### BRIEF DESCRIPTION OF THE DRAWINGS

Detailed descriptions of implementations of the present invention will be described and explained through the use of the accompanying drawings.

FIG. 1 is a block diagram that illustrates a wireless telecommunication network that can implement aspects of the present technology.

FIG. 2 is a block diagram that illustrates 5G core network functions (NFs) that can implement aspects of the present technology.

FIG. 3 shows a communication system including a UE, a repeater, and a satellite.

FIG. 4 is a flowchart of a method to enable low-power communication between a UE and a non-terrestrial network, such as a satellite, according to one embodiment.

FIG. 5 is a flowchart of a method to enable low-power communication between a UE and a non-terrestrial network, such as a satellite, according to another embodiment.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed herein is a system to enable low-power communication between a mobile device and a satellite associated with a wireless telecommunication network. The system can obtain a signal strength associated with a communication provided to the mobile device by a base station of a wireless telecommunication network. Based on the signal strength, the system can determine whether to establish a connection between the mobile device and the base station. Upon determining to not establish the connection with the base station, the system can send a request to the mobile device to connect to a repeater associated with the wireless telecommunication network.

The repeater can include a wireless radio A and a wireless radio B. The radio A can be configured to communicate with the mobile device using a low-power communication, while the radio B is configured to communicate with the satellite using a high-power communication. The repeater can establish a communication channel between the repeater and the mobile device, wherein the communication channel enables the low-power communication of information, thereby avoiding high-power signals at the mobile device of a user. The low-power communication may not exceed 2 watts. The repeater can communicate the information between the radio A and the radio B. The repeater can encode the information into a high-power communication. Finally, the repeater can send the high-power communication to the satellite.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Telecommunication System

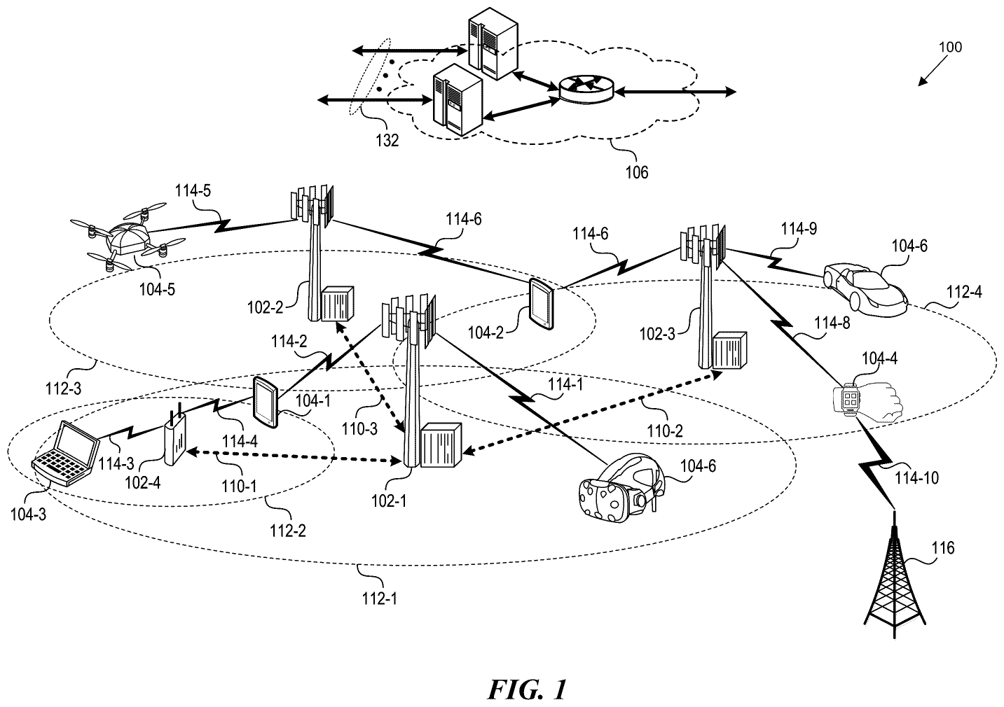

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station radios. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNBs is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. A small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively small geographic area and can allow unrestricted access by wireless devices that have service subscriptions with the network 100 provider. A femto cell covers a relatively small geographic area (e.g., a home) and can provide restricted access by wireless devices having an association with the femto unit (e.g., wireless devices in a closed subscriber group (CSG) or wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (ARNR) connectivity 104-7; portable gaming consoles; wireless routers, gateways, modems, and other fixed wireless access devices; wirelessly connected sensors that provide data to a remote server over a network; IoT devices, such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions, while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple radios for employing radio diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

### 5G Core Network Functions

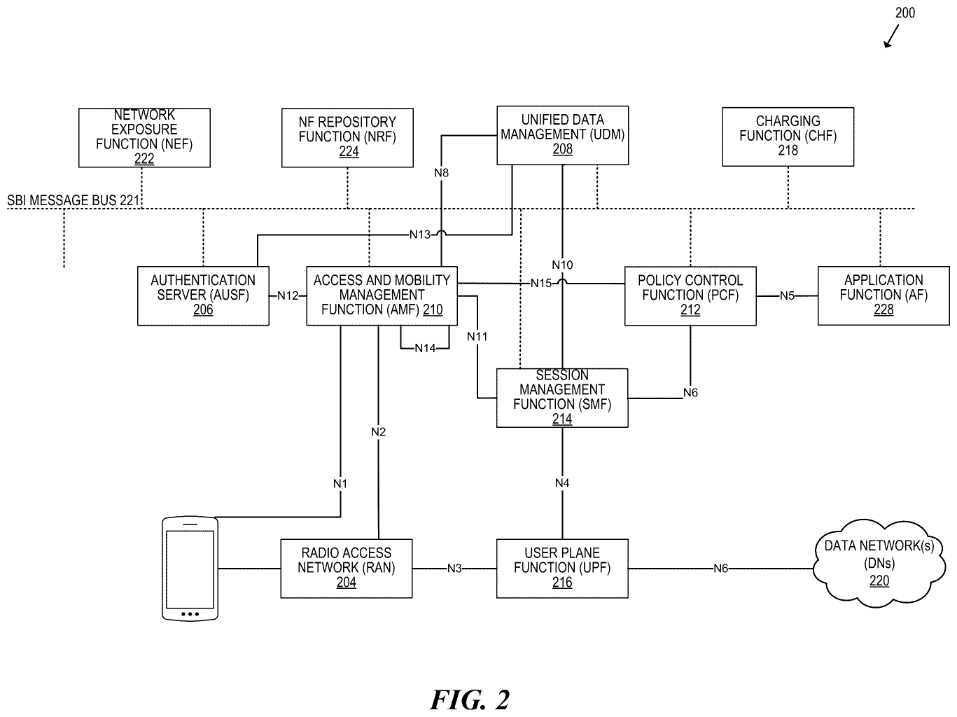

FIG. 2 is a block diagram that illustrates an architecture 200 including 5G core network functions (NFs) that can implement aspects of the present technology. A wireless device 202 can access the 5G network through a NAN (e.g., gNB) of a Radio Access Network (RAN) 204. The NFs include an Authentication Server Function (AUSF) 206, a Unified Data Management (UDM) 208, an Access and Mobility Management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane, and the AMF 210, SMF 214, PCF 212, AUSF 206, and UDM 208 are part of the control plane. One or more UPFs can connect with one or more data networks (DNs) 220. The UPF 216 can be deployed separately from the control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements, and it includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given the large number of wireless devices that can connect to a 5G network, the UDM 208 can contain voluminous amounts of data that is accessed for authentication. Thus, the UDM 208 is analogous to a Home Subscriber Server (HSS), providing authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface, and the N11 interface between the AMF 210 and the SMF 214 assigned by the NRF 224, use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical QoS and charging rules, includes Network Slice selection, which is regulated by the NSSF 226.

### Enabling Low-Power Communication Between a UE And a Non-Terrestrial Network

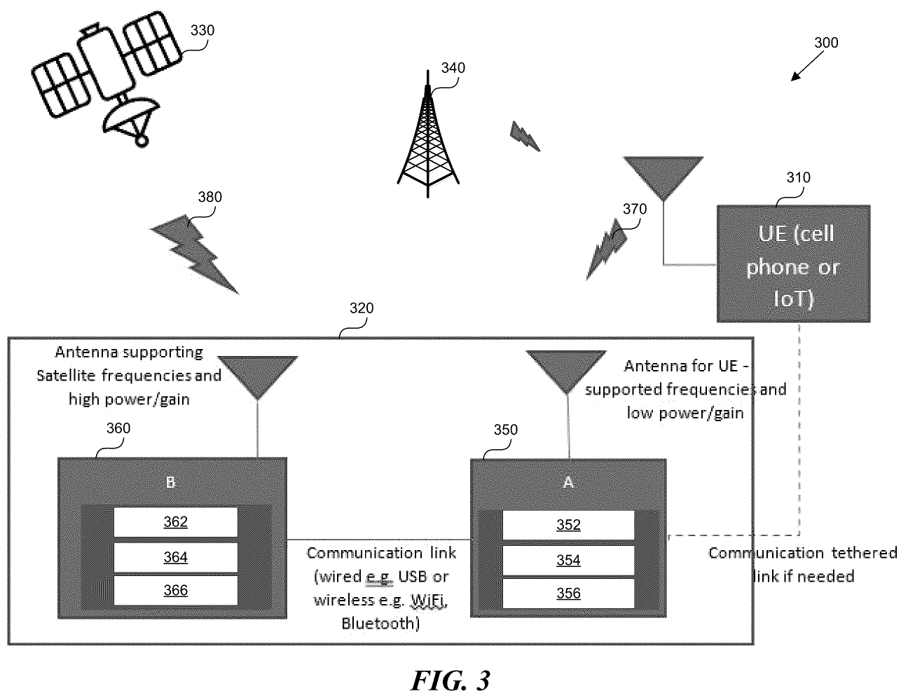

FIG. 3 shows a communication system 300 including a UE 310, a repeater 320, and a satellite 330. Modern cellular wireless voice, video, and data communication is bidirectional and requires communication between a base station 340 and UEs 310. The UE can be a mobile phone, a laptop, a smartwatch, or another IoT device. UEs 310, which are close to or attached to person's body, are configured to engage in low-power communication, such as below 26 decibels per milliwatt (dBm), to limit radio frequency exposure to the human body. This limit on communication power limits the maximum distance that a UE 310 can be from the base station 340 and also the achievable data rate, particularly in the uplink. Typical coverage radius of the base station 340 is 1 km to 10 km.

To increase the radius of communication, such as enabling coverage in rural areas, the disclosed system 300 provides coverage via non-terrestrial networks, including satellites 330 or high-altitude platforms. Non-terrestrial networks can reach every part of the world. Satellites 330 are very high up in the atmosphere, typically between 100 km to 40,000 km high, resulting in high attenuation of the signal between UE 310 and satellites 330. The current maximum transmit power on UEs 310 prevents the signal emitted by the UE from reaching the satellite 330, communicating reliably, and achieving high data throughput.

Moreover, some satellites operate at frequencies that are not supported by UEs 310. For example, some planned low-Earth-orbit satellite systems operate on 18 GHz and above, which are typically not currently supported by UEs 310. To enable connectivity between UEs 310 and non-terrestrial networks, including satellite 330, the disclosed system 300 overcomes the limitations of transmit power and frequency using the repeater 320.

The repeater 320 can include radio A 350 and radio B 360. Radio A 350 of the repeater 320 can communicate with the UE 310 using low-power communication 370 at the frequencies and power available to UE. The radio A 350 can communicate with the UE 310 over the frequency bands supported by the UE, such as cellular bands or short-range wireless frequencies such as WiFi, Bluetooth, etc. The UE 310 can also be tethered to the repeater via USB or another cabled interface if needed.

Radio A 350 can include a baseband 352 and RF system 354 enabling cellular, Wi-Fi, Bluetooth, and/or USB communication with the UE. The radio A 350 can also include a gateway 356 which translates a packetized signal from a cellular network (as defined in 3GPP) to be translated into a format the satellite 330 can understand.

Radio B 360 of the repeater 320 can communicate with the non-terrestrial networks, such as satellite 330, using high-power communication 380 above 26 dBm. Radio B 360 can include a baseband 362, an RF system 364, and a gateway 366 all of which can enable radiofrequency connectivity at high-power. Radio B 360 can communicate with the satellite 330 at the frequency bands supported by the satellite, e.g., a Ka band 18 GHz/30 GHz uplink/downlink, or cellular band used by the UE if supported by the satellite.

The repeater 320 can be installed close to the UE 310. The repeater 320 can have a form factor corresponding to, e.g., be the size of, a tablet, such as an iPad. For example, when the UE 310 is inside a vehicle, the repeater 320 can be installed on the roof of the vehicle or the dashboard. Similarly, the repeater 320 can be installed in a home near a window with a view of the sky/satellite 330.

The repeater 320 can be split into multiple parts. For example, radio A 350 of the repeater 320 can be installed on the dashboard of the vehicle, and radio B 360 can be installed on the roof of the vehicle. In another example, the radio A 350 can be installed inside the house, and radio B 360 can be installed outside the house to have a clear view of the satellite 330.

Using the repeater 320 does not require any hardware modifications on UEs 310; however, software updates may be needed, as described in this application. Hence, users can use their existing UE or IoT devices.

The disclosed system 300 can enable the network 100 in FIG. 1 to provide mobile voice, video, and data communication service to the UE 310 via a non-terrestrial network that complements the cellular network. Also, the disclosed system 300 can provide coverage in areas where there is no cellular network, such as very rural areas, national parks, islands, oceans, other large water bodies, etc.

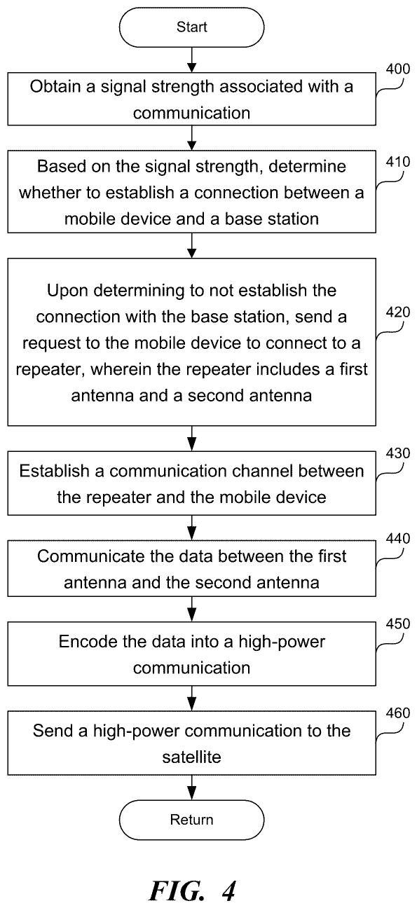

FIG. 4 is a flowchart of a method to enable low-power communication between a UE and a non-terrestrial network, such as a satellite, according to one embodiment. A hardware or software processor can execute instructions described in this application. The processor can be associated with the UE 310 in FIG. 3 or the network 100 in FIG. 1.

In step 400, the processor can obtain a signal strength associated with a communication provided to the UE by a base station associated with the wireless telecommunication network. The signal strength can be measured as signal-to-noise ratio, signal-to-interference-and-noise ratio, Received Signal Strength (RSS), Received Signal Strength Indicator (RSSI), Reference Signal Received Power (RSRP), Reference Signal Received Quality (RSRQ), etc.

In step 410, the processor can, based on the signal strength, determine whether to establish a connection between the UE and the base station. For example, the processor can determine whether the signal strength associated with the UE exceeds a predetermined threshold. The predetermined threshold can be provided by the base station of the wireless telecommunication network and can vary based on the network conditions such as other available base stations, network load, etc.

In step 420, upon determining to not establish the connection with the base station, the processor can send a request to the UE to connect to a repeater associated with the wireless telecommunication network. The repeater can include a first radio and a second radio. The first radio can be configured to communicate with the UE using a low-power communication, and the second radio can be configured to communicate with the satellite using a high-power communication.

In step 430, the processor can establish a communication channel between the repeater and the UE. The communication channel can enable the low-power communication of information, thereby potentially protecting the health of the user associated with the UE. In some cases, the low-power communication cannot exceed 2 watts.

In step 440, the processor can communicate the information between the first radio and the second radio. In step 450, the processor can encode the information into a high-power communication. In step 460, the processor can send the high-power communication to the satellite.

The UE can install software that enables the UE to search for the repeater in addition to searching for the base stations. The software needs to be aware that there may be additional delays in communicating through the repeater with the satellite. Specifically, the base station can be up to 10 km away from the UE, while the satellite can be up to 40,000 km away from the UE. The large difference in distance can cause communication delays.

Usually, in a terrestrial wireless telecommunication network, if a UE does not receive an acknowledgment from the base station upon sending a message, the UE repeats the sent message to the cell tower after a waiting period of e.g., 20 ms. However, given the delay in communicating with the satellite, the UE needs to increase the waiting period to, for example, 30 ms. Consequently, the software needs to modify the UE to resend the message after a 30 ms delay if it does not receive an acknowledgment.

To decide to connect to the repeater, and to adjust the waiting period, the processor can cause the UE to search for a first connection with the base station associated with the wireless telecommunication network and a second connection with the repeater associated with the wireless telecommunication network. The processor can cause the UE to obtain a first signal strength associated with the first connection and a second signal strength associated with the second connection. The processor can cause the UE to determine whether the second signal strength is higher than the first signal strength. Upon determining that the second signal strength is higher than the first signal strength, the processor can establish the second connection with the repeater. Upon establishing the second connection, the processor can cause the UE to increase a waiting period between times when a message is sent and resent to the repeater. The processor can cause the UE to send the message to the repeater. The processor can cause the UE to determine whether an acknowledgment is received from the repeater within the waiting period. Upon determining that the acknowledgment is not received from the repeater within the waiting period, the processor can cause the UE to resend the message to the repeater.

To determine whether to connect to the repeater, the processor can obtain a first signal strength at the UE associated with a first signal provided by the base station associated with the wireless telecommunication network. The processor can obtain a second signal strength at the UE associated with a second signal provided by the repeater associated with the wireless telecommunication network. The processor can determine whether the second signal strength exceeds the first signal strength. Upon determining that the second signal strength exceeds the first signal strength, the processor can send the request to the UE to connect to the repeater.

In case of emergencies, when the base stations of the network are inoperable or overwhelmed, the processor can send notifications to the UEs using the repeater. The processor can determine that the base station configured to provide coverage to the UE is inoperable. Upon determining that the base station is inoperable, the processor can send a notification to the UE using the repeater.

The processor can establish the communication channel using a cellular protocol associated with the wireless telecommunication network, such as a 4G or a 5G protocol, or a short-range wireless protocol, such as Bluetooth.

The UE can measure signal strength between two different repeaters, and when one signal strength is stronger than the other, the UE can choose to connect to the stronger signal strength repeater. The processor can obtain a first signal strength at the UE associated with a first signal provided by a first repeater associated with the wireless telecommunication network. The processor can obtain a second signal strength at the UE associated with a second signal provided by a second repeater associated with the wireless telecommunication network. The processor can determine whether the second signal strength exceeds the first signal strength. Upon determining that the second signal strength exceeds the first signal strength, the processor can send the request to the UE to connect to the second repeater.

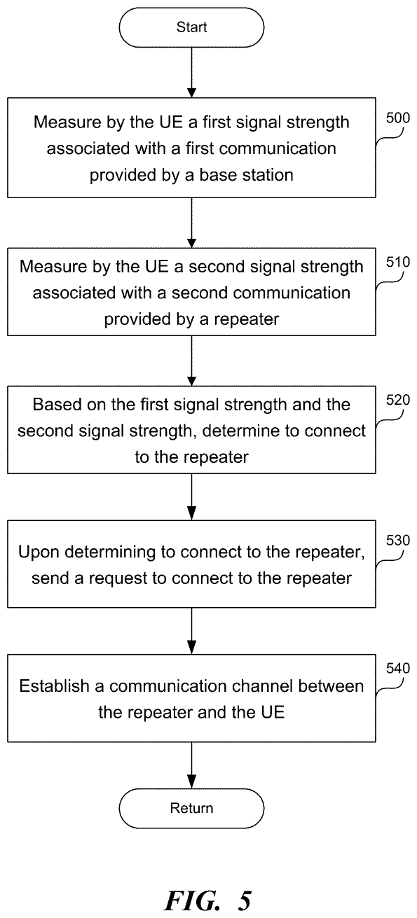

FIG. 5 is a flowchart of a method to enable low-power communication between a UE and a non-terrestrial network, such as a satellite, according to another embodiment. In step 500, a processor associated with the UE can measure a first signal strength associated with a first communication provided by a base station associated with the wireless telecommunication network to the UE.

In step 510, the processor can measure a second signal strength associated with a second communication provided by a repeater associated with the wireless telecommunication network to the UE.

In step 520, based on the first signal strength and the second signal strength, the processor can determine to connect to the repeater. In step 530, upon determining to connect to the repeater, the processor can send a request to connect to the repeater associated with the wireless telecommunication network. The repeater can include a first radio and a second radio, wherein the first radio is configured to communicate with the UE using the low-power communication and wherein the second radio is configured to communicate with the satellite using a high-power communication.

In step 540, the processor can establish a communication channel between the repeater and the UE, wherein the communication channel enables the low-power communication of information, thereby avoiding exposing the user associated with the UE to high-power signals. The repeater is configured to communicate the information between the first radio and the second radio. The repeater is configured to encode the information into a high-power communication. The repeater is configured to send the high-power communication to the satellite.

The processor can search for a first connection with the base station associated with the wireless telecommunication network and a second connection with the repeater associated with the wireless telecommunication network. The processor can obtain a first signal strength associated with the first connection and a second signal strength associated with the second connection. The processor can determine whether the second signal strength is higher than the first signal strength. Upon determining that the second signal strength is higher than the first signal strength, the processor can establish the second connection with the repeater. Upon establishing the second connection, the processor can increase a waiting period before resending a message sent to the repeater. The processor can send the message to the repeater. The processor can determine whether an acknowledgment is received from the repeater within the waiting period. The processor can, upon determining that the acknowledgment is not received from the repeater within the waiting period, resend the message to the repeater.

The processor can obtain a first signal strength at the UE associated with a first communication provided by the base station associated with the wireless telecommunication network. The processor can obtain a second signal strength at the UE associated with a second communication provided by the repeater associated with the wireless telecommunication network. The processor can determine whether the second signal strength exceeds the first signal strength. Upon determining that the second signal strength exceeds the first signal strength, the processor can send the request to the UE to connect to the repeater.

The processor can determine that the base station associated with a wireless telecommunication network is inoperable, wherein the base station is configured to provide coverage to the UE. Upon determining that the base station is inoperable, the processor can send a notification to the UE using the repeater.

The processor can establish the communication channel using a cellular protocol associated with the wireless telecommunication network or a short-range wireless protocol.

The processor can obtain a first signal strength at the UE associated with a first communication provided by a first repeater associated with the wireless telecommunication network. The processor can obtain a second signal strength at the UE associated with a second communication provided by a second repeater associated with the wireless telecommunication network. The processor can determine whether the second signal strength exceeds the first signal strength. Upon determining that the second signal strength exceeds the first signal strength, the processor can send the request to the UE to connect to the second repeater.

### Computer System

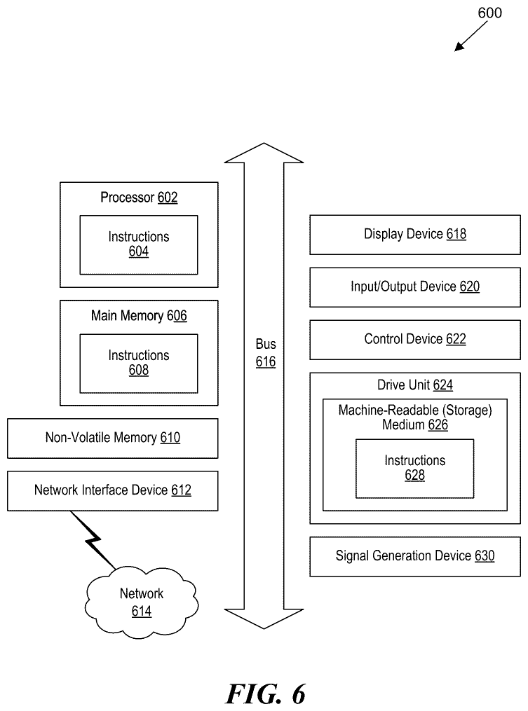

FIG. 6 is a block diagram that illustrates an example of a computer system 600 in which at least some operations described herein can be implemented. As shown, the computer system 600 can include one or more processors 602, main memory 606, non-volatile memory 610, a network interface device 612, a video display device 618, an input/output device 620, a control device 622 (e.g., a keyboard and pointing device), a drive unit 624 that includes a machine-readable (storage) medium 626, and a signal generation device 630, all of which are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the Figures and any other components described in this specification can be implemented.

The computer system 600 can take any suitable physical form. For example, the computer system 600 can share an architecture similar to that of a server computer, personal computer (PC), tablet computer, mobile telephone, game console, music player, wearable electronic device, network-connected (“smart”) device (e.g., a television or home assistant device), AR/VR system (e.g., a head-mounted display), or any electronic device capable of executing a set of instructions that specify action(s) to be taken by the computer system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, near real time, or in batch mode.

The network interface device 612 enables the computer system 600 to mediate data in a network 614 with an entity that is external to the computer system 600 through any communication protocol supported by the computer system 600 and the external entity. Examples of the network interface device 612 include a network adaptor card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable (storage) medium 626) can be local, remote, or distributed. Although shown as a single medium, the machine-readable (storage) medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computer system 600. The machine-readable (storage) medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media, such as volatile and non-volatile memory devices 610, removable flash memory, hard disk drives, optical disks, and transmission-type media, such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computer system 600 to perform operations to execute elements involving the various aspects of the disclosure.

### Remarks

The terms “example”, “embodiment,” and “implementation” are used interchangeably. For example, reference to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms in either this application or in a continuing application.

I/We claim:

1. At least one computer-readable storage medium, excluding transitory signals and carrying instructions to enable low-power communication between a mobile device, associated with a wireless telecommunication network, and a satellite, which, when executed by at least one data processor of a system, cause the system to:
obtain a signal strength measurement associated with a communication provided to the mobile device by a base station associated with the wireless telecommunication network;
based on the signal strength measurement, determine whether to establish a connection between the mobile device and the base station;
upon determining to not establish the connection between the mobile device and the base station, send a request to the mobile device to connect to a repeater associated with the wireless telecommunication network,
wherein the repeater includes a first wireless radio and, connected thereto, a second wireless radio,
wherein the first wireless radio is configured to communicate with the mobile device using the low-power communication, and
wherein the second wireless radio is configured to communicate with the satellite using a high-power communication;
establish a communication channel between the repeater and the mobile device,
wherein the communication channel enables the low-power communication of information, thereby reducing high-powered signaling at the mobile device;
communicate the information between the first wireless radio and the second wireless radio;
encode the information into a high-power communication; and
send the high-power communication to the satellite.

2. The at least one computer-readable storage medium of claim 1, comprising instructions to:
cause the mobile device to search for a first connection with the base station associated with the wireless telecommunication network and a second connection with the repeater associated with the wireless telecommunication network;
cause the mobile device to obtain a first signal strength measurement associated with the first connection and a second signal strength measurement associated with the second connection;
cause the mobile device to determine whether the second signal strength measurement is higher than the first signal strength measurement;
upon determining that the second signal strength measurement is higher than the first signal strength measurement, establish the second connection with the repeater;
upon establishing the second connection, cause the mobile device to increase a waiting period between times when a message is sent and resent to the repeater;
cause the mobile device to send the message to the repeater;
cause the mobile device to determine whether an acknowledgment is received from the repeater within the waiting period; and
upon determining that the acknowledgment is not received from the repeater within the waiting period, cause the mobile device to resend the message to the repeater.

3. The at least one computer-readable storage medium of claim 1, comprising instructions to:
obtain a first signal strength measurement at the mobile device associated with a first communication provided by the base station associated with the wireless telecommunication network;
obtain a second signal strength measurement at the mobile device associated with a second communication provided by the repeater associated with the wireless telecommunication network;
determine whether the second signal strength measurement exceeds the first signal strength measurement; and
upon determining that the second signal strength measurement exceeds the first signal strength measurement, send the request to the mobile device to connect to the repeater.

4. The at least one computer-readable storage medium of claim 1, comprising instructions to:
determine that the base station associated with the wireless telecommunication network is inoperable,
wherein the base station is configured to provide coverage to the mobile device; and
upon determining that the base station is inoperable, send a notification to the mobile device using the repeater.

5. The at least one computer-readable storage medium of claim 1, the instructions to establish the communication channel between the repeater and the mobile device comprising instructions to:
establish the communication channel using a cellular protocol associated with the wireless telecommunication network or a short-range wireless protocol.

6. The at least one computer-readable storage medium of claim 1, comprising instructions to:
obtain a first signal strength measurement at the mobile device associated with a first communication provided by a first repeater associated with the wireless telecommunication network;
obtain a second signal strength measurement at the mobile device associated with a second communication provided by a second repeater associated with the wireless telecommunication network;
determine whether the second signal strength measurement exceeds the first signal strength measurement; and
upon determining that the second signal strength measurement exceeds the first signal strength measurement, send a second request to the mobile device to connect to the second repeater.

7. The at least one computer-readable storage medium of claim 1, wherein a form factor associated with the repeater corresponds to a form factor associated with a tablet.

8. A system comprising:
at least one hardware processor; and
at least one non-transitory memory storing instructions, which, when executed by the at least one hardware processor, cause the system to:
cause a UE to determine a signal strength associated with a communication provided to the UE by a base station associated with a wireless telecommunication network;
based on the determined signal strength, cause the UE to determine whether to establish a connection with the base station;
upon determining to not establish the connection between the UE and the base station, send a request to the UE to connect to a repeater associated with the wireless telecommunication network,
wherein the repeater includes a first wireless radio and a second wireless radio,
wherein the first wireless radio is configured to communicate with the UE using a low-power communication, and
wherein the second wireless radio is configured to communicate with a non-terrestrial network using a high-power communication;
establish a communication channel between the repeater and the UE,
wherein the communication channel enables the low-power communication of information;
communicate the information between the first wireless radio and the second wireless radio;
encode the information into a high-power communication; and
send the high-power communication to the non-terrestrial network.

9. The system of claim 8, comprising instructions to:
cause the UE to search for a first connection with the base station associated with the wireless telecommunication network and a second connection with the repeater associated with the wireless telecommunication network;
cause the UE to obtain a first signal strength associated with the first connection and a second signal strength associated with the second connection;
cause the UE to determine whether the second signal strength is higher than the first signal strength;
upon determining that the second signal strength is higher than the first signal strength, establish the second connection with the repeater;
upon establishing the second connection, cause the UE to increase a waiting period between times when a message is sent and resent to the repeater;
cause the UE to send the message to the repeater;
cause the UE to determine whether an acknowledgment is received from the repeater within the waiting period; and
upon determining that the acknowledgment is not received from the repeater within the waiting period, cause the UE to resend the message to the repeater.

10. The system of claim 8, comprising instructions to:
obtain a first signal strength at the UE associated with a first communication provided by the base station associated with the wireless telecommunication network;
obtain a second signal strength at the UE associated with a second communication provided by the repeater associated with the wireless telecommunication network;
determine whether the second signal strength exceeds the first signal strength; and
upon determining that the second signal strength exceeds the first signal strength, send the request to the UE to connect to the repeater.

11. The system of claim 8, comprising instructions to:
determine that the base station associated with the wireless telecommunication network is inoperable,
wherein the base station is configured to provide coverage to the UE; and
upon determining that the base station is inoperable, send a notification to the UE using the repeater.

12. The system of claim 8, the instructions to establish the communication channel between the repeater and the UE comprising instructions to:
establish the communication channel using a cellular protocol associated with the wireless telecommunication network or a short-range wireless protocol.

13. The system of claim 8, comprising instructions to:
obtain a first signal strength at the UE associated with a first communication provided by a first repeater associated with the wireless telecommunication network;
obtain a second signal strength at the UE associated with a second communication provided by a second repeater associated with the wireless telecommunication network;
determine whether the second signal strength exceeds the first signal strength; and
upon determining that the second signal strength exceeds the first signal strength, send a second request to the UE to connect to the second repeater.

14. The system of claim 8, wherein a form factor associated with the repeater corresponds to a form factor associated with a tablet.

15. A system comprising:
at least one hardware processor; and
at least one non-transitory memory storing instructions, which, when executed by the at least one hardware processor, cause the system to:
measure by a UE a first signal strength associated with a first communication provided by a base station associated with a wireless telecommunication network to the UE;
measure by the UE a second signal strength associated with a second communication provided by a repeater associated with the wireless telecommunication network to the UE;
based on the first signal strength and the second signal strength measurements, determine to connect to the repeater;
upon determining to connect to the repeater, send a request to connect to the repeater associated with the wireless telecommunication network,
wherein the repeater includes a first wireless radio and a second wireless radio,
wherein the first wireless radio is configured to communicate with the UE using a low-power communication, and
wherein the second wireless radio is configured to communicate with a non-terrestrial network using a high-power communication;
establish a communication channel between the repeater and the UE,
wherein the communication channel enables the low-power communication of information,
wherein the repeater is configured to communicate the information between the first wireless radio and the second wireless radio,
wherein the repeater is configured to encode the information into a high-power communication; and
wherein the repeater is configured to send the high-power communication to the non-terrestrial network.

16. The system of claim 15, comprising instructions to:
search for a first connection with the base station associated with the wireless telecommunication network and a second connection with the repeater associated with the wireless telecommunication network;
obtain a first signal strength measurement associated with the first connection and a second signal strength measurement associated with the second connection;
determine whether the second signal strength measurement is higher than the first signal strength measurement;
upon determining that the second signal strength measurement is higher than the first signal strength measurement, establish the second connection with the repeater;
upon establishing the second connection, increase a waiting period between times when a message is sent and resent to the repeater;
send the message to the repeater;
determine whether an acknowledgment is received from the repeater within the waiting period; and
upon determining that the acknowledgment is not received from the repeater within the waiting period, resend the message to the repeater.

17. The system of claim 15, comprising instructions to:
obtain a first signal strength measurement at the UE associated with a first communication provided by the base station associated with the wireless telecommunication network;
obtain a second signal strength measurement at the UE associated with a second communication provided by the repeater associated with the wireless telecommunication network;
determine whether the second signal strength measurement exceeds the first signal strength measurement; and
upon determining that the second signal strength measurement exceeds the first signal strength measurement, send the request to the UE to connect to the repeater.

18. The system of claim 15, comprising instructions to:
determine that the base station associated with the wireless telecommunication network is inoperable,
wherein the base station is configured to provide coverage to the UE; and
upon determining that the base station is inoperable, send a notification to the UE using the repeater.

19. The system of claim 15, the instructions to establish the communication channel between the repeater and the UE comprising instructions to:
establish the communication channel using a cellular protocol associated with the wireless telecommunication network or a short-range wireless protocol.

20. The system of claim 15, comprising instructions to:
obtain a first signal strength measurement at the UE associated with a first communication provided by a first repeater associated with the wireless telecommunication network;
obtain a second signal strength measurement at the UE associated with a second communication provided by a second repeater associated with the wireless telecommunication network;
determine whether the second signal strength measurement exceeds the first signal strength measurement; and
upon determining that the second signal strength measurement exceeds the first signal strength measurement, send a second request to the UE to connect to the second repeater.
